(19) United States
(12) Patent Application Publication
(10) Pub. No.: US 2005/0175327 A1
(43) Pub. Date: Aug. 11, 2005

(54) Heat exchanger provided for heating purposes and comprising an electric heating device

(75) Inventors: Peter Englert, Bad Friedrichshall (DE); Michael Kohl, Biefjheim (DE); Matthias Traub, Korntal-Munchingen (DE)

Correspondence Address: FOLEY AND LARDNER;SUITE 500, 3000 K STREET NW, WASHINGTON, DC, 20007, US

(73) Assignee: BEHR GmbH & CO. KG

(21) Appl. No.: 10/510,681

(22) PCT Filed: Apr. 11, 2003
(86) PCT No.: PCT/EP03/03770

(30) Foreign Application Priority Data
Apr. 12, 2002 (DE) 102 16 157.7

(51) Int. Cl. F24D 13/00; B60L 1/02

(52) U.S. Cl. 392/347; 219/202

(57) ABSTRACT

The invention relates to a heat exchanger provided for heating purposes, particularly for a motor vehicle, comprising: a number of parallel pipes, at least one electric heating device (4), which is mounted each time between two adjacent pipes, and comprising a number of fin elements (5) situated between each pair of adjacent pipes and between each heating device (4) and the pipes adjacent thereto. In order to be able to better control the power absorption of the heating devices (4), each heating device (4) comprises two separately controllable heating sections (6, 7). One heating section (6) is placed on one side (8) of the heating device (4) facing one adjacent pipe, whereas the other heating section (7) is placed on an opposite side (9) of the heating device (4) facing the other adjacent pipe.

The present invention relates to a heat exchanger provided for heating purposes, in particular for a motor vehicle, having the features of the preamble of claim 1.

A heat exchanger of this type is known, for example, from DE 198 35 229 A1 and possesses a plurality of parallel tubes and a plurality of electrical heating devices which are arranged in each case between two adjacent tubes. Furthermore, a plurality of rib elements are provided, which are arranged in each case between tubes arranged in pairs and between each heating device and the tubes adjacent to the latter. A heat exchanger of this type is used, for example, in a motor vehicle in a heating circuit of an air treatment system, in order to heat air which is supplied to a vehicle interior. For this purpose, the liquid of the heating circuit circulates in the tubes. The air to be heated flows between the tubes through the rib elements. During normal operation, in this case, the hot heating liquid transmits heat to the tubes and from these to the rib elements. The heat then passes from the rib elements to the air. In the event that sufficient heat cannot be supplied via the heating liquid, the electrical heating devices are provided, which, when activated, convert electrical current into heat and transmit this to the rib elements.

In the known heat exchanger, each heating device contains an individual heating section which may expediently be formed by at least one PTC element. The heating section is connected to the rib elements in a heat-transmitting manner in each case on two outer sides located opposite one another. So that a sufficiently uniform heating of the airflow can be ensured, a plurality of heating devices of this type are inserted approximately uniformly between the ribs of the heat exchanger. In this case, the selected number of these heating devices cannot be any desired, since, for normal operation, there must be a sufficiently large number of tubes so that the necessary transmission of heat to the airflow can be ensured. The current requirement of the individual heating section is relatively high, so that, in use in a motor vehicle, it is necessary, in specific operating states of the vehicle, to disconnect one or more heating sections in order to avoid an overloading of the current supply network of the vehicle. If a plurality of heating sections are disconnected, however, uniform heating in the airflow can no longer be achieved, and this may lead to losses of comfort.

The present invention is concerned with the problem of specifying, for a heat exchanger of the type initially mentioned, an improved embodiment which, in particular, can be controlled in a simpler way with regard to its current requirement.

This problem is solved, according to the invention, by means of the subject of the independent claim. Advantageous embodiments are the subject matter of the dependent claims.

The invention is based on the general idea of equipping the individual heating devices in each case with two heating sections which can be activated separately and which transfer their heat to the rib elements directly or indirectly on two opposite sides of the heating device. In this case, each heating section has at least one heating element which is preferably designed as a PTC element. By virtue of the construction according to the invention, with a number of heating devices which remains the same, it is possible to accommodate double the number of heating sections in the heat exchanger. With the heating capacity remaining the same, therefore, the electrical power at the individual heating sections can be halved. Owing to the construction according to the invention, it is consequently possible to adapt the connection and disconnection of individual heating sections more effectively to the instantaneous load capacity of the current network to which the heating devices are connected.

A simplified construction may be achieved in that each heating device has a tubular housing which possesses two mutually parallel side walls, on the outer sides of which the rib elements are arranged in a heat-transmitting manner and on the inner sides of which the heating sections are arranged in a heat-transmitting manner.

In a development, each heating device may contain two pressure plates which in each case bear against one of the heating sections and are pressed apart from one another by means of at least one spring element in order to press the heating sections against the side walls of the housing. By the heating sections being pressed actively against the housing, an intensive transmission of heat from the heating sections to the housing can be ensured.

In a particularly advantageous embodiment, the housing and the pressure plates may be designed as electrical conductors, in which case, in each heating section, the inner side bearing against the respective pressure plate forms a first electrical connection of this heating section, while the outer side bearing against the respective side wall of the housing forms a second electrical connection of this heating section. Furthermore, the two pressure plates are electrically insulated with respect to one another.

So that the two electrically conductive pressure plates can be insulated electrically with respect to one another, the following measures may be employed alternatively or cumulatively:
the spring element may be of electrically insulating design,
an electrical insulator may be arranged between the spring element and at least one of the pressure plates,
the spring element may be equipped, at least in a contact region bearing against one of the pressure plates, with an electrically insulating film, coating, lacquering, anodizing and/or surface,
at least one of the pressure plates may be equipped, at least in a contact region bearing against the spring element, with an electrically insulating film, coating, lacquering and/or surface.

Further important features and advantages of the invention may be gathered from the subclaims, from the drawings and from the accompanying figure description with reference to the drawings.

It goes without saying that the features mentioned above and those yet to be explained below can be used not only in the combinations specified in each case, but also in other combinations or alone, without departing from the scope of the present invention.

Preferred exemplary embodiments of the invention are illustrated in the drawings and are explained in more detail in the following description, the same reference symbols relating to identical or functionally identical or similar components.

In the drawings, in each case diagrammatically,

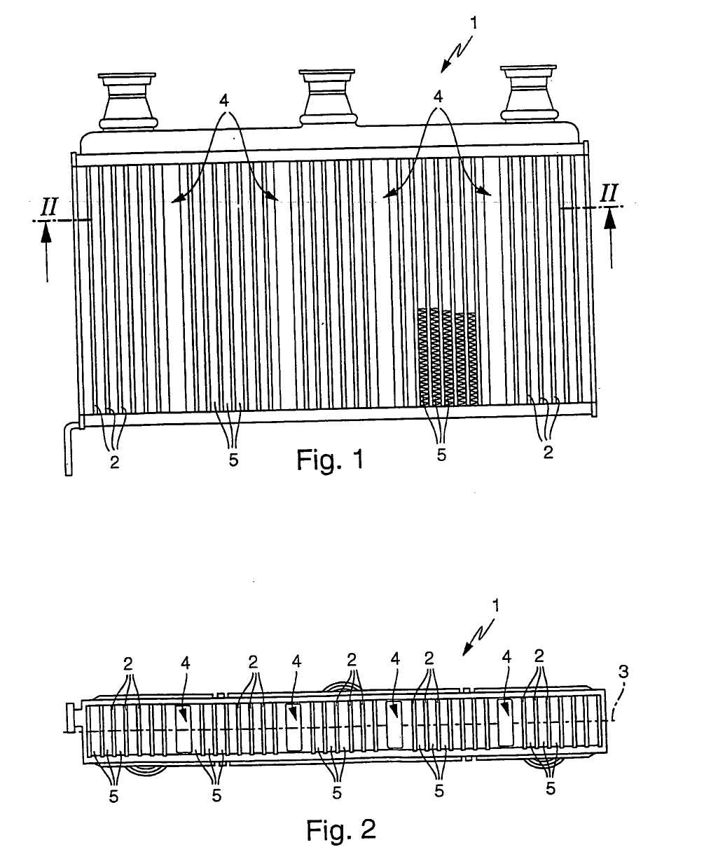

FIG. 1 shows a front view of a heat exchanger according to the invention,

FIG. 2 shows a sectional view of the heat exchanger according to FIG. 1 along the sectional lines II in FIG. 1,

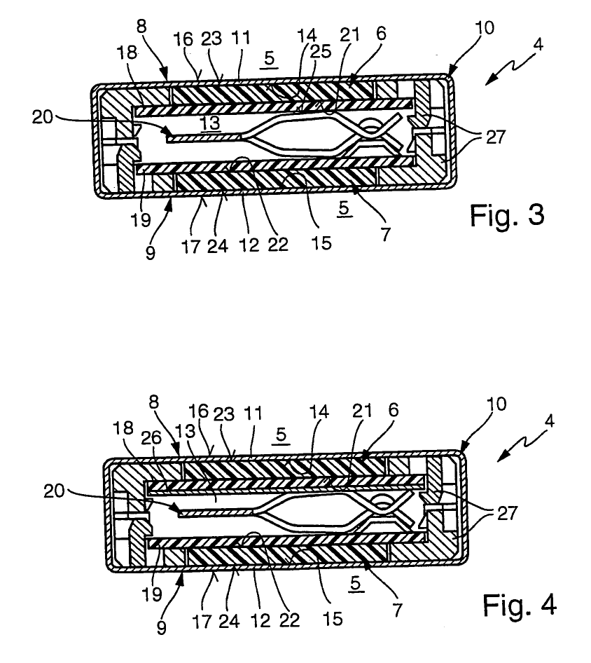

FIGS. 3 to 6 show cross sections through various embodiments of heating devices of the heat exchanger.

According to FIGS. 1 and 2, a heat exchanger 1 according to the invention consists of a multiplicity of tubes 2 which are arranged parallel to one another. Conventionally, these tubes 2 are arranged next to one another in one plane which corresponds to the drawing plane in FIG. 1 and is designated by 3 in FIG. 2. The tubes 2 are designed here as what are known as “flat tubes” and with this possess a cross section which has a considerably larger dimensioning transversely to the plane 3 than parallel to the plane 3. The heat exchanger 1, moreover, possesses a plurality of, here four, electrical heating devices 4 which likewise run parallel to the tubes 2 and at the same time are arranged in each case between two adjacent tubes 2. Furthermore, a multiplicity of rib elements 5 is provided, the ribs of which run in such a way that the flow can pass through them transversely to the plane 3. On the one hand, the rib elements 5 are arranged in each case between tubes 2 adjacent to one another in pairs. On the other hand, such rib elements 5 are arranged in each case between each heating device 4 and the tubes 2 adjacent to the latter.

The heat exchanger 1 is preferably used in an air treatment system of a motor vehicle for heating, as a function of requirements, an airflow which is to be supplied to a vehicle interior. For this purpose, the airflow is routed transversely to the plane 3 through the heat exchanger 1. The heat exchanger 1 is then connected to a heating circuit, so that a heating liquid circulates in the tubes 2 of the heat exchanger 1. This heating circuit may be integrated, for example, into a cooling circuit of an internal combustion engine of the vehicle. The transmission of heat from the heating liquid to the airflow takes place in this case via the tubes 2 and the rib elements 5.

In the event that the heating liquid cannot provide sufficient heat energy, the heating devices 4 are supplied with current, corresponding current connections not being illustrated here.

According to FIGS. 3 to 6, each heating device 4 contains two heating sections 6 and 7 which in each case extend parallel to the tubes 2. Expediently, in this case, each heating section 6, 7 extends along the entire length of the heating device 4, that is to say along the entire length of the tubes 2. The two heating sections 6, 7 are arranged on sides 8 and 9 of the heating device 4 which are located opposite one another. The arrangement and orientation of the two heating sections 6, 7 are in this case such that each heating section 6, 7 faces a tube 2 adjacent to the heating device 4.

According to the invention, the two heating sections 6, 7 can be triggered or activated independently of one another.

In the embodiments shown here, moreover, the heat exchanger possesses at least one tubular housing 10 which has two mutually parallel side walls 11 and 12 on the two opposite sides 8, 9, of the heating device 4. The heating sections 6, 7 are in this case accommodated in the inside 13 of the housing 10, each heating section 6, 7 bearing in a heat-transmitting manner in each case against an inner side 14 and 15 of the side walls 11, 12. Furthermore, these side walls 11, 12 are connected in a heat-transmitting manner on their outer side 16 and 17 in each case to one of the rib elements 5. This gives rise correspondingly to a heat-transmitting coupling of the heating sections 6, 7 to the rib elements 5 via the side walls 11, 12.

In order to press the heating sections 6, 7 against the side walls 11, 12 in order to improve the heat transmission, the inside 13 of the housing 10 has arranged in it two pressure plates 18 and 19 which bear in each case on the inner side 21 and 22 of the respective heating sections 6, 7, said inner side facing away from the side wall 11, 12. Furthermore, a plurality of spring elements 20 may be provided, only one of which is illustrated in each case in FIGS. 3 to 6 and which are arranged between the pressure plates 18, 19 and press the latter outward apart from one another. Thus, with the aid of the spring elements 20, the pressure plates 18, 19 are pressed against the heating sections 6, 7 and the heating sections 6, 7 are pressed against the side walls 11, 12.

According to a particularly advantageous embodiment, the housing 10 and the pressure plates 18, 19 are designed as electrical conductors. In particular, the housing 10 and the pressure plates 18, 19 are produced from metal. The heating sections 6, 7 used in this case are designed in such a way that, in each heating section 6, 7, the inner side 21 or 22 against which the respective pressure plate 18 or 19 bears, forms a first electrical connection of the respective heating section 6, 7. Furthermore, in each heating section 6, 7, an outer side 23 or 24 with which the respective heating section 6, 7 bears against the respective side wall 11, 12 of the housing 10 is designed as a second electrical connection of the respective heating section 6, 7.

So that the heating sections 6, 7 can be supplied with electrical current, it is therefore sufficient to connect the pressure plates 18, 19 and the housing 10 correspondingly to a current supply. Since the two heating sections 6, 7 can be activated independently of one another for heating, it is necessary also to connect the two heating sections 6, 7 to the respective current supply independently of one another. For this purpose, the two pressure plates 18, 19 must be insulated with respect to one another.

The mutual insulation of the two pressure plates 18, 19 may be implemented in various ways.

For example, according to FIG. 3, it is possible for the spring element or spring elements 20 to have an electrically insulating design. For example, each spring element 20 consists of an electrically nonconductive material. It is likewise possible to insulate the respective spring element 20 electrically, at least in a contact region 25 in which the spring element 20 bears against one of the two pressure plates 18, 19. This insulation may be achieved, for example, by means of an insulating film, coating, lacquering or anodizing. It is likewise possible to provide this contact region 25 with an electrically insulating surface by means of anodizing.

According to FIG. 4, the desired insulation may also be achieved in that an electrical insulator 26 is arranged between the spring elements 20 and one of the pressure plates 18, 19. An insulator 26 of this type may consist, for example, of a suitable plastic or be formed, for example, by a mica film or by glass fiber reinforced epoxy resin.

According to FIGS. 3 to 5, for the simplified positioning of the heating sections 6, 7 in the housing 10, a carrier 27 is arranged, on which, for example, the pressure plates 18, 19 can be snapped in. With the aid of a carrier 27 of this type, the mounting of the heating devices 4 can be simplified considerably.

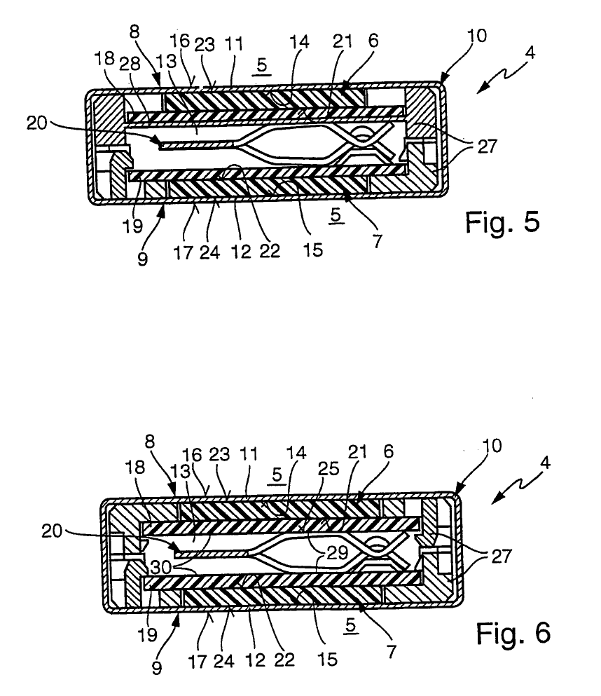

According to FIG. 5, in a particular embodiment, this carrier 27 may have a partition 28 which is positioned in such a way that, on the one hand, one pressure plate 18 bears against this partition 28 and, on the other hand, the spring element 20 presses on said partition. In this case, the material used for the carrier 27 is elastic to an extent such that the pressure force of the spring element 20 can be transmitted essentially to the pressure plate 18 bearing against the partition 28. Furthermore, the carrier 27 is produced from an electrically insulating material, at least in the region of its partition 28, with the result that the desired insulation of the two pressure plates 18, 19 with respect to one another is implemented. In the event that the carrier 27 is produced from plastic by means of an injection molding, it is expedient for the carrier 27, at least in the region of its partition 28, to be injection-molded directly onto the respective pressure plate 18. This, too, may result in a simplification in the production of the heating device 4. The partition 28 may extend along the entire length of the pressure plate 18. It is likewise possible for the partition 28 to extend as a web only in the region of the spring element 20, in which case a plurality of web-shaped partitions 28 may also be provided according to the number of spring elements 20.

According to FIG. 6, to achieve the desired insulation between the two pressure plates 18, 19, in the case of one or both of the pressure plates 18, 19, at least one contact region 29 in which the spring element 20 bears against the respective pressure plate 18, 19 may be provided with a suitable electrical insulation 30. This insulation 30 may be formed, for example, by an electrically insulating film, coating or lacquering. It is likewise possible to form the insulation 30 by means of an electrically insulating surface which has been produced by means of anodizing.

The coating or lacquering used for producing the insulation on the respective carrier plate 18, 19 or on the respective spring element 20 may be achieved, for example, by means of a lacquer applied in a single-layer or multilayer manner and resistant to high temperature or by means of a Teflon coating or by means of a glass fiber coating. It is likewise possible to glue a high temperature polyester film to the respective pressure plate 18, 19 or to the spring element 20. Furthermore, an aluminum adhesive tape may also be used, which has been made insulating in a suitable way, for example by means of an electrically insulating film, coating or lacquering. Moreover, the various insulation possibilities mentioned may be combined with one another. Layer thicknesses of 10 to 500 μm are possible, and it must always be ensured that the respective insulation is dimensioned such that it withstands the spring force generated by the respective spring element 20 during the entire intended service life of the heat exchanger 1. The insulating coating or film must be configured in such a way that it is not subject to any thermoplastic deformability over the entire service life of the heat exchanger 1.

The integration according to the invention of two heating sections 6, 7 activatable or actuable independently of one another into a heating device 4 makes it possible to have a power consumption of the heating devices 4 which is improved, in particular is graded relatively finely. It is thereby possible to utilize the available power optimally, in order, as required, to heat the airflow additionally by an activation of more or of fewer heating sections 6, 7. The use of heating devices 4 which in each case contain two heating sections 6, 7 at the same time ensures, on the one hand, that existing designs of the heat exchanger 1 do not have to be changed or have to be changed only insignificantly. On the other hand, moreover, a uniform introduction of heat into the airflow is achieved, even when not all the heating sections 6, 7 of all the heating devices 4 are active.

Preferably, each of the heating sections 6, 7 is formed from at least one PTC element. A PTC element is a semiconductor which, on the one hand, emits heat when subjected to current and, on the other hand, has a mounting electrical resistance with increasing heat. The result of this is that, when subjected to current, a PTC element of this type adjusts itself automatically to a predetermined temperature.

### LIST OF REFERENCE SYMBOLS

1 Heat exchanger
2 Tube
3 Plane
4 Heating device
5 Rib element
6 Heating section
7 Heating section
8 Side of 10
9 Side of 10
10 Housing
11 Side wall of 10
12 Side wall of 10
13 Inside of 10
14 Inner side of 11
15 Inner side of 12
16 Outer side of 11
17 Outer side of 12
18 Pressure plate
19 Pressure plate
20 Spring element
21 Inner side of 6
22 Inner side of 7
23 Outer side of 6
24 Outer side of 7
25 Contact region of 20
26 Insulator
27 Carrier
28 Partition of 27
29 Contact region of 18, 19
30 Insulation/coating/lacquering/film/surface

1. A heat exchanger provided for heating purposes, in particular for a motor vehicle,
having a plurality of parallel tubes (2),
having at least one electrical heating device (4) which is or are arranged in each case between two adjacent tubes (2),
having a plurality of rib elements (5) which are arranged in each case between tubes (2) adjacent to one another in pairs and between each heating device (4) and the tubes (2) adjacent to the latter,
characterized
in that each heating device (4) has two separately activatable heating sections (6, 7),
one heating section (6) being arranged on a side (8) of the heating device (4) which faces one adjacent tube (2),
while the other heating section (7) is arranged on an opposite other side (9) of the heating device (4) which faces the other adjacent tube (2).

2. The heat exchanger as claimed in claim 1,
characterized
in that each heating device (4) is arranged in a tubular housing (10) which has two mutually parallel side walls (11, 12), on the outer sides (16, 17) of which the rib elements (5) are arranged in a heat-transmitting manner and on the inner sides (14, 15) of which the heating sections (6, 7) are arranged in a heat-transmitting manner.

3. The heat exchanger as claimed in claim 1,
characterized
in that each heating device (4) contains two pressure plates (18, 19) which in each case bear against one of the heating sections (6, 7) and are pressed apart from one another by means of at least one spring element (20) in order to press the heating sections (6, 7) against the side walls (11, 12) of the housing (10).

4. The heat exchanger as claimed in claim 3,
characterized
in that the housing (10) and the pressure plates (18, 19) are designed as electrical conductors,
in that, in each heating section (6, 7), its inner side (21, 22) bearing against the respective pressure plate (18, 19) forms a first electrical connection of the heating section (6, 7), while its outer side (23, 24) bearing against the respective side wall (11, 12) of the housing (10) forms a second electrical connection of the heating section (6, 7),
in that the two pressure plates (18, 19) are electrically insulated with respect to one another.

5. The heat exchanger as claimed in claim 4,
characterized
in that the spring element (20) is of electrically insulating design.

6. The heat exchanger as claimed in claim 4,
characterized
in that an electrical insulator (26) is arranged between the spring element (20) and at least one of the pressure plates (18, 19).

7. The heat exchanger as claimed in claim 4,
characterized
in that the spring element (20), at least in a contact region (25) bearing against one of the pressure plates (18,19), and/or at least one of the pressure plates (18, 19), at least in a contact region (29) bearing against the spring element (20), is equipped with an electrically insulating film and/or coating and/or lacquering and/or has a surface electrically insulating by means of anodizing.

8. The heat exchanger as claimed in claim 2,
characterized
in that a carrier (27) for positioning the heating sections (6, 7) is arranged in the housing (10).

9. The heat exchanger as claimed in claim 8
characterized
in that the carrier (27) has at least one partition (28), against which, on the one hand, one of the pressure plates (18, 19) bears and against which, on the other hand, the at least one spring element (20) presses,
in that the carrier (27) is designed as an electrical insulator, at least in the region of its partition (28).

10. The heat exchanger as claimed in claim 9,
characterized
in that the carrier (27) is a plastic injection molding which, in the region of its partition (28) is injection-molded onto the respective pressure plate (18, 19).

11. The heat exchanger as claimed in claim 1,
characterized
in that each heating section (6, 7) is designed as a PTC element.
